(19) United States
(12) Patent Application Publication
(10) Pub. No.: US 2026/0141156 A1
(43) Pub. Date: May 21, 2026

(54) ANALOG ELECTRICAL CIRCUIT SWITCH ARCHITECTURE

(71) Applicant: MaxLinear, Inc., Carlsbad, CA (US)

(72) Inventors: Curtis Ling, Carlsbad, CA (US); Sridhar Ramesh, Carlsbad, CA (US)

(73) Assignee: MaxLinear, Inc., Carlsbad, CA (US)

(21) Appl. No.: 19/397,714

(22) Filed: Nov. 21, 2025

Related U.S. Application Data
(60) Provisional application No. 63/723,524, filed on Nov. 21, 2024.

(51) Int. Cl. G06F 30/394; G06F 115/02

(52) U.S. Cl. CPC G06F 30/394; G06F 2115/02

(57) ABSTRACT

A device may include a first plurality of electronic devices comprising a plurality of ports operable to facilitate communications via a plurality of lanes; a second plurality of electronic devices operable to communicate with the first plurality of electronic devices via the plurality of lanes; and a third plurality of electronic devices operable to communicate with the second plurality of electronics devices via a plurality of connections.

### RELATED APPLICATION

This application claims the benefit of U.S. Provisional Application No. 63/723,524, filed November 21, 2024, the disclosure of which is incorporated herein by reference in its entirety for all purposes.

### BACKGROUND

Unless otherwise indicated herein, the materials described herein are not prior art to the claims in the present application and are not admitted to be prior art by inclusion in this section.

High-speed network environments face increasing demands for ultra-low latency and energy-efficient communication systems, driven by advancements in data-intensive applications such as real-time analytics, cloud computing, and artificial intelligence. Known network switching architectures, often relying on packet-based designs, have limitations that hinder their ability to meet these demands. Internal buffering and packet inspection, used in such systems, introduce significant latency, increase power consumption, and add complexity to network management.

Modern networking applications often use dynamic and flexible connectivity between devices to accommodate fluctuating traffic patterns and real-time communication. However, static or fixed-path routing techniques may be ill-equipped to address these challenges, frequently resulting in inefficient bandwidth utilization, congestion, and delays. These limitations may be further exacerbated in scenarios having high throughput and deterministic communication, such as hyperscale data centers and telecommunications infrastructure.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

A device may include a first set of electronic devices including a set of ports to facilitate communications via a set of lanes; a second set of electronic devices to communicate with the first set of electronic devices via the set of lanes; and a third set of electronic devices to communicate with the second set of electronics devices via a set of connections.

A device may include a first set of electronic devices including a set of ports to facilitate communications via a set of lanes; and a second set of electronic devices to communicate with the first set of electronic devices via the set of lanes, in which the second set of electronic devices includes analog crossbar integrated circuits.

A device may include a first set of electronic devices including a set of ports to facilitate communications via a set of lanes; and a second set of electronic devices to communicate with the first set of electronic devices via the set of lanes, in which the second set of electronic devices includes digital crossbars.

### DESCRIPTION OF DRAWINGS

So that the manner in which the above recited features of the present disclosure can be understood in detail, a more particular description of the disclosure, briefly summarized above, may be had by reference to embodiments, some of which are illustrated in the appended drawings. It is noted, however, that the appended drawings illustrate only some aspects of this disclosure and the disclosure may admit to other equally effective embodiments.

To facilitate understanding, identical reference numerals have been used, where possible, to designate identical elements that are common to the figures. It is contemplated that elements and features of one embodiment may be beneficially incorporated in other embodiments without further recitation.

FIG. 1A illustrates an example block diagram of a data center;

FIG. 1B illustrates an example switch device;

FIG. 1C illustrates an example switch device;

FIG. 1D illustrates an example switch device;

FIG. 2 illustrates an example switch device;

FIG. 3 illustrates an example network topology for a switch device;

FIG. 4 illustrates an example block diagram for an artificial intelligence (AI) rack;

FIG. 5 illustrates an example block diagram for an analog fabric switch;

FIG. 6 illustrates an example analog fabric topology;

FIG. 7 illustrates an example block diagram for a digital fabric switch;

FIG. 8A illustrates an example block diagram for a network using an analog fabric switch and a digital fabric switch;

FIG. 8B illustrates an example block diagram for a network using photonic interfaces;

FIG. 9 illustrates an example block diagram for a digital switch system on chip (SOC);

FIG. 10 illustrates an example block diagram for a digital circuit switch;

FIG. 11 illustrates an example of a network topology;

FIG. 12 illustrates an example communication system; and

FIG. 13 illustrates a schematic of an exemplary computing device

### DETAILED DESCRIPTION

The present disclosure will now be described in detail with reference to the drawings, which are provided as illustrative examples of the disclosure so as to enable those skilled in the art to practice the disclosure. Notably, the figures and examples below are not meant to limit the scope of the present disclosure to a single embodiment, but other embodiments are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the disclosure.

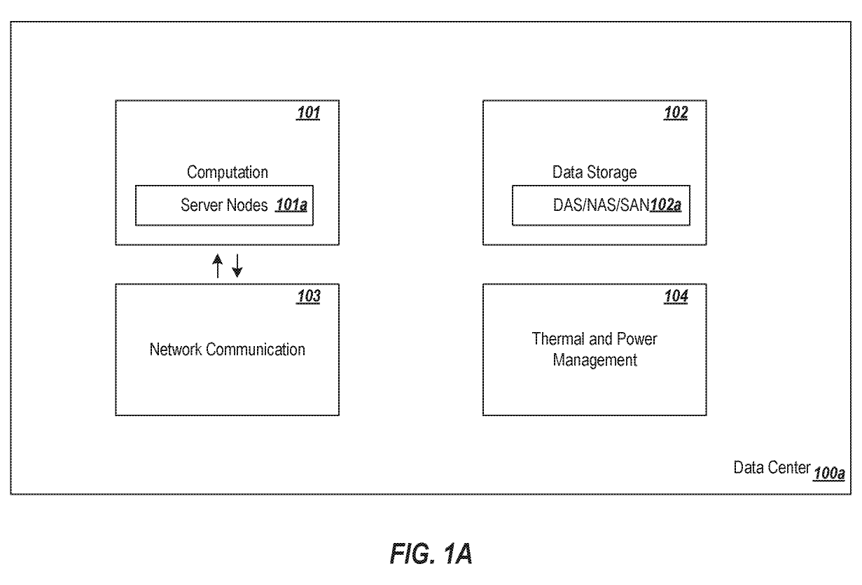

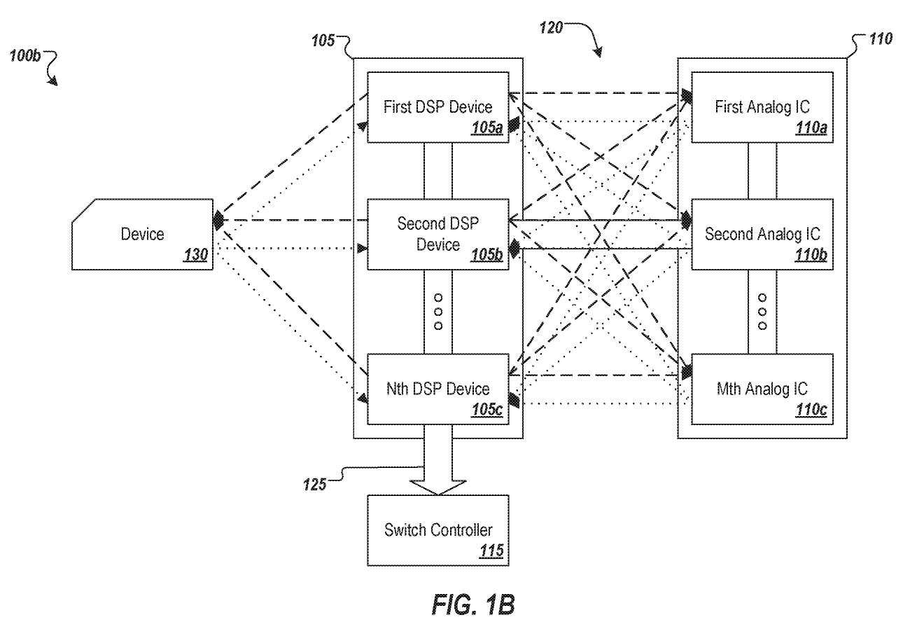

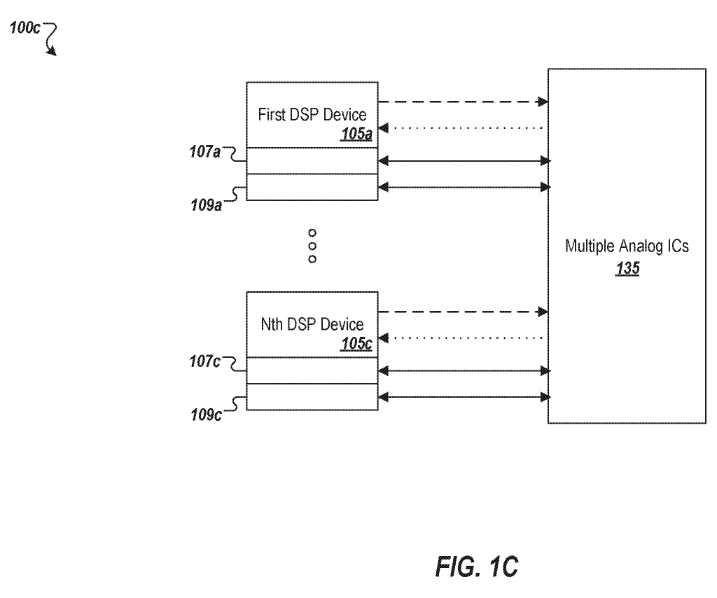

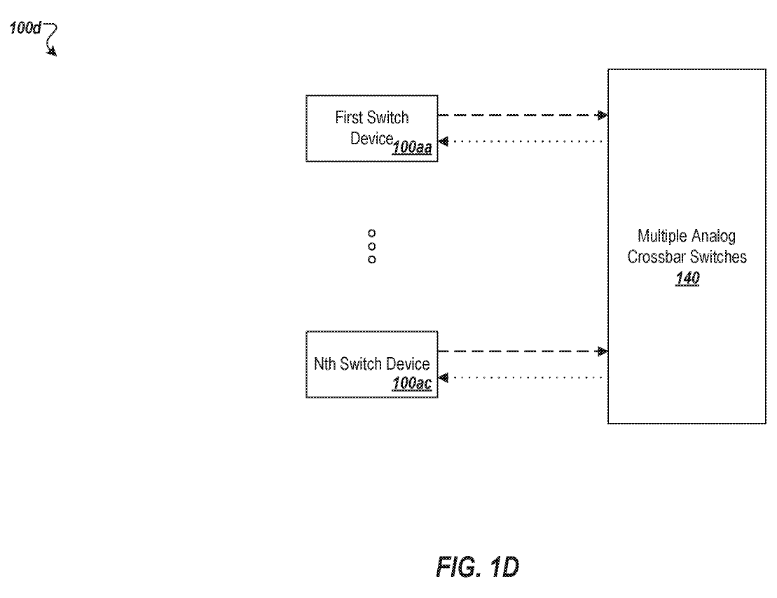

As illustrated in FIG. 1, a block diagram of a data center 100a may include multiple subsystems configured to perform various operational functions, including computation 101, data storage 102, network communication 103, and thermal and power management 104. The computation 101 subsystem may include one or more server nodes 101a that may execute software applications and process data workloads. The data storage 102 subsystem may provide persistent data retention through devices such as hard disk drives, solid-state drives, or distributed storage arrays, which may be organized in configurations such as Direct Attached Storage (DAS), Network Attached Storage (NAS), or Storage Area Networks (SAN) 102a. The networking communication 103 subsystem may facilitate bidirectional data transfer between servers and external networks through high-speed switching and routing components. The thermal and power management 104 subsystem may maintain operational integrity by regulating temperature and supplying uninterrupted electrical power, e.g., through redundant power sources and cooling mechanisms. Each subsystem may operate in coordination to ensure continuous availability, scalability, and fault tolerance and the ability to scale up and scale out in response to increasing computational and storage demands.

The architecture of a data center 100a may include multiple physical and logical components that collectively enable high-performance computing and data handling. The compute layer may include server racks populated with processors optimized for general-purpose or specialized workloads, including central processing units (CPUs), graphics processing units (GPUs), and field-programmable gate arrays (FPGAs). The storage layer may incorporate hierarchical storage systems that may employ high-speed interfaces such as Non-Volatile Memory Express (NVMe) to reduce latency. The networking layer may use top-of-rack switches, aggregation switches, and core routers arranged in various topologies, (e.g., crossbar, Clos, leaf-spine, etc.) to provide non-blocking connectivity and minimize hop count between endpoints. Power distribution units (PDUs), uninterruptible power supplies (UPS), and backup generators may form the electrical infrastructure, while cooling systems may employ air-based or liquid-based heat dissipation techniques to maintain thermal stability. These components may be integrated to achieve high reliability, modular scalability, and compliance with performance requirements, enabling the system to scale up and scale out as operational loads increase.

In operation, a data center may process client requests through a multi-stage workflow that includes traffic distribution, application execution, and data retrieval. Incoming requests may be received by a load balancing system configured to allocate workloads across multiple compute nodes to prevent resource saturation. Application servers may execute the requested operations, which may involve accessing structured or unstructured data stored within the storage subsystem. Virtualization technologies may enable multiple virtual machines to operate on a single physical server, thereby optimizing resource utilization. Containerization frameworks, such as those implementing Linux containers, may provide isolated execution environments for microservices and facilitate rapid deployment across heterogeneous hardware. The networking subsystem may ensure deterministic packet routing and congestion management through high-speed interconnects and software-defined networking protocols. This operational workflow may be designed to maintain low latency, high throughput, and fault-tolerant performance under variable load conditions, while supporting the ability to scale up and scale out dynamically.

Conventional data center implementations may exhibit several advancements aimed at improving efficiency, scalability, and sustainability. Hyperscale architectures may employ large-scale server clusters interconnected through high-bandwidth fabrics to support cloud computing and artificial intelligence workloads. Edge computing deployments may position micro data centers proximate to end-user devices to reduce network latency and enable real-time processing. Specialized accelerators, including GPUs and tensor processing units (TPUs), may be increasingly integrated to support machine learning and high-performance computing applications. Energy efficiency initiatives may incorporate renewable energy sources and advanced cooling methodologies, such as liquid immersion cooling, to reduce operational costs and environmental impact. These trends reflect an industry-wide transition toward architectures that may be highly distributed, workload-optimized, and environmentally sustainable.

A scale-up network architecture may be characterized by the addition of resources within a single network node or chassis to increase capacity. In such configurations, performance improvements may be achieved by augmenting the processing capability, memory, or port density of an existing switch or router. This approach may involve deploying high-capacity modular switches with vertically integrated backplanes and high-bandwidth switch fabrics. The scale-up model may be advantageous for environments having centralized control and minimal inter-node latency, as all traffic may be processed within a single logical device.

A scale-out network architecture may be characterized by the horizontal expansion of network capacity through the addition of multiple interconnected nodes. In this configuration, performance and scalability may be achieved by distributing workloads across multiple switches, for example arranged as a leaf-spine architecture. Each leaf switch may provide connectivity to compute and storage resources, while spine switches interconnect the leaf layer to form a non-blocking, high-bandwidth fabric. The scale-out model may enable incremental capacity expansion without completely replacing existing infrastructure, thereby supporting elastic growth and fault tolerance. This architecture may be particularly suited for large-scale data centers and cloud environments, where traffic patterns may be highly distributed and use predictable bandwidth. Scale-out networks may leverage parallelism and redundancy to achieve near-linear scalability.

A scale-up network may carry information, including AI training and inference algorithms, among computing units (such as graphics processing units (GPUs)). These networks may have various characteristics such as high bandwidth (e.g., non-blocking all-to-all bandwidth), low latency (e.g., minimize layers of switching and per-switch latency), and scalability (e.g., supporting high numbers of interconnected GPUs and low energy per bit transferred through network). For purposes of this disclosure, a “GPU” has been provided as an example and instances of GPU may be substituted by any type of processor such as CPUs, ASICs, or the like.

Conventional scale-up networks may centralize the switching/routing function in order to scale GPU connectivity across multiple rack units and even multiple racks. An example compute rack may include 18 compute trays consuming about 6kW each, and 9 switch trays consuming about 1kW each. Each GPU may have 18 ports of 100GB/s each (or 1.8TB/s per GPU), and the rack network (which may be implemented using a copper backplane) may connect each GPU to the 9 switch trays to provide each GPU with the ability to deliver all of its 1.8TB/s to any other GPU in the rack, a capability often referred to as “All-to-All bandwidth”. This may be used for parallelizing the computation of an AI model for training or inference purposes.

This rack-level power density may be quite high and push the limit of electrical power and thermal cooling densities, leaving little room for additional compute trays. Furthermore, switch connectivity for all-to-all crossbar-like functionality has complexity and power which may vary quadratically with the number of ports being interconnected, so scaling the GPUs connected within a rack may be constrained, even when the number of GPUs may be increased.

A centralized full crossbar may be replaced with distributed crossbars which places ultra-efficient, ultra-low-latency analog crossbars locally with their respective GPUs, and routes them to digital switch SOCs with an arrangement of crossbars which may be simplified compared with full crossbars. This may drive improvements in network power, latency, complexity, and scalability.

As a result, network traffic (e.g., which may be AI traffic) may be matched with low predictable latency providing all-to-all bandwidth. Compared to Ethernet packet switches, 1/5 of the power may be consumed. The device may be capable of high radix implementations (e.g., 1024 lanes). The device may be usable in all-copper backplane scale ups as well as with multi-mode (MM) fiber.

Thus, the examples described herein present systems and methods for an Analog Electrical Circuit Switch (AECS) switch capable of ultra-low-latency (e.g., <5ns, 10 ns, or the like) and low-power switching across a flexible any-to-any crossbar architecture. The AECS switch eliminates internal buffering and packet inspection within the crossbar, allowing for a highly efficient and scalable architecture. A programmable crossbar configuration may dynamically map input ports to output ports in response to real-time traffic conditions.

An example system may include advanced control mechanisms for broadcasting and multicasting data from a single input to multiple outputs, optimizing resource allocation and minimizing overhead. Make-before-break (MBB) protocols may be employed to ensure seamless reconfiguration of crossbar connections without data loss, even during high-speed operations. Additionally, adaptive equalization techniques may be integrated into the system, allowing the AECS to optimize signal quality based on feedback from connected devices.

An architecture may include redundancies along with digital signal processors (DSPs) configured to support any-to-any connections. In such an arrangement, low-latency switching along with low power use per lane may be achieved. Further, memory included in the DSPs may be used for any storage or buffering and each of the components included in the switch may include redundant lanes such that degradations or broken DSPs may be rerouted around and replaced without losses to the system. The reconfiguration in the switch may be dynamically performed (e.g., such as in view of real-time traffic managed by the switch) by a switch controller that may communicate with the components in the switch using out-of-band traffic so as to not interfere with the in-band communications otherwise being handled by the switch.

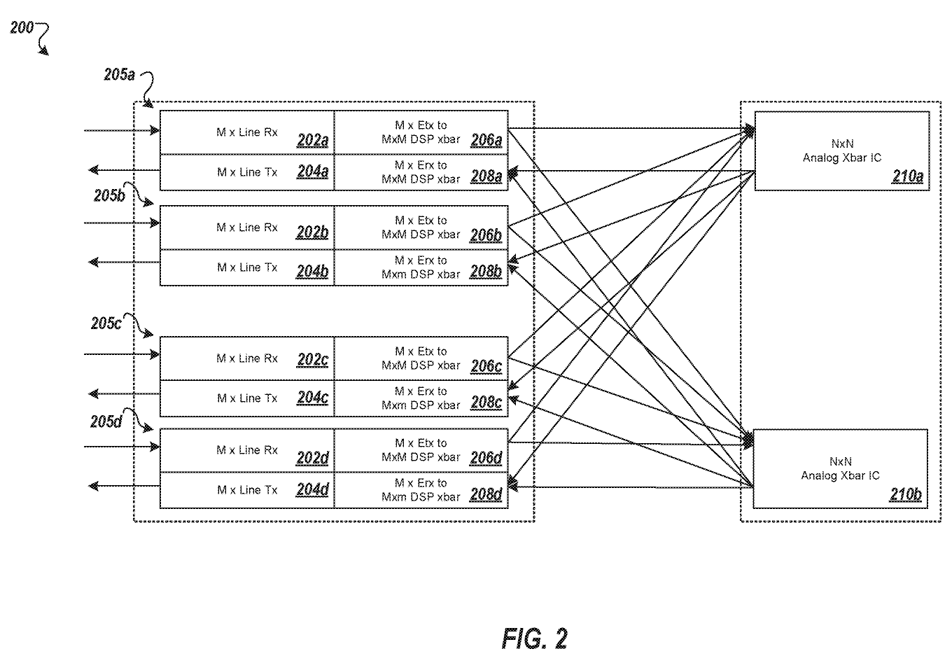

FIG. 1B illustrates an example switch device 100b. The switch device 100b may include a first digital signal processor (DSP) device 105a, a second DSP device 105b, an nth DSP device 105c, referred to collectively as multiple first electronic devices 105, a first analog integrated circuit (IC) 110a, a second analog IC 110b, an mth analog IC 110c, referred to collectively as multiple second electronic devices 110, a switch controller 115, in-band traffic 120, and out-of-band traffic 125. First DSP 105a, second DSP 105b, and nth DSP 105c may have input and output as shown in greater detail with respect to FIG. 2.

The switch device 100b may be reconfigurable (e.g., in terms of the connections between the components therein, such as the multiple first electronic devices 105 and the multiple second electronic devices 110, the switch controller 115, and/or a device 130), where the switching of the connections/lanes between the components may be low latency (e.g., less than 5 ns, 10ns, or the like switching). Alternatively, or additionally, the switch device 100b may reconfigure without the use of retiming such that each lane of the multiple lanes included therein may use less than 50 mW of power. For example, each lane of the multiple lanes may support 100G bandwidth while using less than 50 mW of power.

The multiple first electronic devices 105 may individually include one or more ports that may be used to facilitate communications within the switch device 100b, such as between the multiple first electronic devices 105 and the multiple second electronic devices 110, the switch controller 115, and/or a device 130. The communications in the switch device 100b may be transmitted via multiple lanes in the switch device 100b. The multiple lanes may facilitate the in-band traffic 120 and/or the out-of-band traffic 125.

The multiple lanes between the multiple first electronic devices 105 and the multiple second electronic devices 110 may be in an any-to-any configuration. For example, the first DSP device 105a may include a lane to the first analog IC 110a, to the second analog IC 110b, and/or the mth analog IC 110c. A similar arrangement may occur for each of the multiple first electronic devices 105, such that each DSP device of the multiple first electronic devices 105 may include a lane to any number of the multiple second electronic devices 110, including none of the multiple second electronic devices 110. As illustrated in FIG. 1, each lane for facilitating the in-band traffic 120 may be in both directions (e.g., transmit and receive) between the multiple first electronic devices 105, the multiple second electronic devices 110, and/or a device 130. Alternatively, or additionally, the lanes are dashed/dotted to illustrate that for any transmit/receive path between the multiple first electronic devices 105, the multiple second electronic devices 110, and/or a device 130, a lane may or may not be present.

The multiple first electronic devices 105, the multiple second electronic devices 110, and/or the switch controller 115 may be disposed on a printed circuit board (PCB) where traces on the PCB may be used to connect at least the multiple first electronic devices 105, the multiple second electronic devices 110, and/or the switch controller 115 (e.g., the traces on the PCB may facilitate the in-band traffic 120 and/or the out-of-band traffic 125 in the switch device 100b). Alternatively, or additionally, the multiple first electronic devices 105, the multiple second electronic devices 110, and/or the switch controller 115 may be connected to one another using connectors, such as high-speed cables, where the multiple first electronic devices 105, the multiple second electronic devices 110, and/or the switch controller 115 may individually include ports/headers to support the use of the connectors. In instances in which the connectors are used, crosstalk between the multiple lanes in the switch device 100b may be reduced relative to the crosstalk that may occur when the switch device 100b uses traces on a PCB.

The switch device 100b, including the multiple first electronic devices 105, the multiple second electronic devices 110, and/or the switch controller 115, may be utilized with one or more additional switches and/or crossbar devices to form a new crossbar switch device, which may be larger than any one of the switch devices 100b. For example, as illustrated and discussed relative to FIG. 1C, the switch device 100b may be utilized with any other number of switch devices 100b (e.g., the nth switch device 100ac in FIG. 1C) and multiple analog crossbar switches 140 to form a new crossbar switch device.

The multiple first electronic devices 105 may be digital signal processors (DSPs) and/or the multiple second electronic devices 110 may be analog circuit switch integrated circuits (ICs) for use with electrical signals. Alternatively, or additionally the multiple second electronic devices 110 may be analog optical circuit switch ICs for use with optical signals. The multiple first electronic devices 105 may be individually configured to support one or more layer of the open systems interconnection (OSI) model. For example, each of the multiple first electronic devices 105 may be configured to support layer 1 protocols, layer 2 protocols, and/or layer 3 protocols with respect to the in-band traffic 120 and/or the out-of-band traffic 125.

Each, or at least one, of the multiple first electronic devices 105 may support layer 1 protocols, which may include detecting and/or processing layer 2 protocols and/or layer 3 protocols, handling layer 2 protocol and/or layer 3 protocol addressability, frame header detection, packet header inspection, responding to layer 2 protocol and/or layer 3 protocol requests, storing information in response to a request associated with layer 2 protocols and/or layer 3 protocols, updating information in response to a request associated with layer 2 protocols and/or layer 3 protocols, communicating information in response to a request associated with layer 2 protocols and/or layer 3 protocols, optimizing information in response to a request associated with layer 2 protocols and/or layer 3 protocols, etc. Each of the multiple first electronic devices 105 may be able to adjust the way in which traffic is directed through it, such as in response to a command from the switch controller 115. For example, each of the multiple first electronic devices 105 may be operable to configure an internal switch, an external switch, or a crossbar based on the various layer protocol processing to be performed.

The first DSP device 105a may receive a communication that includes a frame header (or a packet header) and the first DSP device 105a may be configured to detect the frame header and decode the frame header along with any associated contents of the communication, all within the first DSP device 105a. In a second example, the first DSP device 105a may integrate a media access control (MAC) address lookup table which may allow the first DSP device 105a to configure one or more crossbars such that the first DSP device 105a may facilitate connectivity between any two MAC addresses that are included in the lookup table. Alternatively, or additionally, each of the first electronic devices 105 may include a lookup table that may store equalization settings that may be used for various connections between the first electronic devices 105 and other components within the switch device 100b. The equalization settings in the lookup table may be used to accelerate acquisition and/or tracking for a particular DSP device of the multiple first electronic devices 105 when the particular DSP device switches connections within the switch device 100b.

The multiple first electronic devices 105 may be configured to respond to layer 2 protocol requests and/or layer 3 protocol requests for connectivity and/or resource grant requests. For example, the multiple first electronic devices 105 may compare a request to a lookup table that includes priority levels and the multiple first electronic devices 105 may be operable to configure themselves and/or associated crossbars and/or switches based on the determined priority level. Alternatively, or additionally, each of the multiple first electronic devices 105 may be configured to respond to in-band requests (e.g., granting a connection request, signaling backpressure to the device 130, etc.), collect statistics on traffic handled by the multiple first electronic devices 105 (e.g., link utilization and/or traffic type), and/or perform data filtering (e.g., detecting a particular header, performing routing, generating flags and/or interrupts, and/or logging any of the filtering events).

The multiple first electronic devices 105 may be configured to communicate with (e.g., transmit data to and/or receive data from) the device 130. The communication with the device 130 may include in-band traffic 120. In such instances, the communications between the multiple first electronic devices 105 and the device 130 may be line-side communications, where the lines may facilitate communications using various communication channels. For example, the line-side communications between the multiple first electronic devices 105 and the device 130 may be an electrical-to-electrical connection, an optical-to-optical connection, an electrical-to-optical connection, or an optical-to-electrical connection, and so forth.

The device 130 may address communications directly to one of the multiple first electronic devices 105. For example, the device 130 may address communications to the second DSP device 105b. Alternatively, or additionally, the device 130 may address communications to the switch controller 115, which may then direct communications to the appropriate DSP device. For example, the device 130 may address communications intended for the second DSP device 105b to the switch controller 115 and the switch controller 115 may direct the communications to the second DSP device 105b.

The multiple first electronic devices 105 may individually include memory that may be used as a buffer for communications through the multiple first electronic devices 105. The memory in the multiple first electronic devices 105 may be utilized to buffer incoming and/or outgoing traffic, which may include in-band traffic 120 and/or out-of-band traffic 125. Due to the memory in the multiple first electronic devices 105 being distributed (e.g., by the distributed nature of the multiple first electronic devices 105), the switch device 100b may not include any memory for buffering in addition to the memory included in the multiple first electronic devices 105.

The multiple first electronic devices 105 may individually include one or more additional lanes that may be used for communications in the switch device 100b. Further details associated with the additional lanes are included in the description associated with FIG. 1C.

The multiple second electronic devices 110 may individually include one or more ports that may be used to facilitate communications within the switch device 100b, similar to the ports described relative to the multiple first electronic devices 105. Alternatively, or additionally, the lanes for communications between the multiple first electronic devices 105 and the multiple second electronic devices 110 may be coupled with the ports included in the multiple second electronic devices 110.

The switch controller 115 may be a microcontroller unit (MCU). Alternatively, or additionally, the switch controller 115 may be a DSP, or other processing device. The switch controller 115 may be communicatively coupled with at least the multiple first electronic devices 105 and/or the multiple second electronic devices 110. The switch controller 115 may resolve resource grant requests, distribute the network state to the multiple first electronic devices 105 and/or to the multiple second electronic device 110, and/or may establish and/or maintain timing among the components included in the switch device 100b.

The switch controller 115 may communicate with the multiple first electronic devices 105 and/or the multiple second electronic devices 110 using a separate connection/lane than the connections between the multiple first electronic devices 105 and the multiple second electronic devices 110. For example, the first connection between the multiple first electronic devices 105 and the multiple second electronic devices 110 may facilitate the in-band traffic 120 and the second connection between the switch controller 115 and the multiple first electronic devices 105 and/or the multiple second electronic devices 110 may facilitate the out-of-band traffic 125.

The out-of-band traffic 125 may use a different network than the in-band traffic 120. Alternatively, or additionally, the out-of-band traffic 125 may use a different physical layer protocol than the in-band traffic 120. The out-of-band traffic 125 may be used to manage and/or configure one or more components included in the switch device 100b. For example, the switch controller 115 may communicate with the multiple first electronic devices 105 using the out-of-band traffic 125 to reconfigure lanes and/or traffic routing based on the traffic through the switch device 100b.

The switch controller 115 may be programmable such that the switch controller 115 may be operable to dynamically map the lanes between the multiple first electronic devices 105 and the multiple second electronic devices 110. For example, in instances in which the first DSP device 105a includes a lane to the first analog IC 110a, the switch controller 115 may dynamically map the lane to be from the first DSP device 105a to the second analog IC 110b. The switch controller 115 may dynamically adapt the mapping of the lanes between the multiple first electronic devices 105 and the multiple second electronic devices 110 based on one or more conditions and/or a satisfaction of a threshold related to the conditions. For example, in instances in which the real-time data traffic in the switch device 100b (or an amount of real-time data traffic handled by one of the multiple first electronic devices 105 and/or one of the multiple second electronic devices 110) satisfies a threshold, the switch controller 115 may dynamically adapt the mapping of the lanes as described.

The switch device 100b may include one or more redundant lanes that may be used in various situations during operation of the switch device 100b. For example, one or more redundant lanes may be used for the out-of-band traffic 125, such as signaling using the out-of-band traffic 125. In such instances, the out-of-band signaling may be transmitted and/or received by a particular DSP device and/or by the switch controller 115, and the out-of-band signaling may be a lower transmission rate than the in-band traffic 120. In another example, one or more redundant lanes may be used for out-of-bandwidth broadcasts from the switch controller 115 and/or from one or more of the multiple first electronic devices 105 to other devices in the switch device 100b (e.g., such as other DSP devices).

The switch controller 115 may reserve a portion of bandwidth associated with the in-band traffic 120 in the switch device 100b. The bandwidth reserved by the switch controller 115 may be reserved on a per lane basis of the multiple lanes included in the switch device 100b. For example, a first lane between the first DSP device 105a and the first analog IC 110a may have a first reserved bandwidth and a second lane between the second DSP device 105b and the second analog IC 110b may have a second reserved bandwidth, where the amount of bandwidth reserved may be the same or may differ between the first reserved bandwidth and the second reserved bandwidth. The switch controller 115 may allocate resources within the switch device 100b based on predicted or anticipated traffic (e.g., based on a probabilistic model).

Alternatively, or additionally, the switch controller 115 may monitor the lanes of the multiple lanes in the switch device 100b. The switch controller 115 may monitor the multiple lanes periodically and/or in a round robin manner, such that the lanes of the multiple lanes may observed to determine if failures or degradations may be present in a lane. In instances in which a lane experiences a degradation that satisfies a threshold for an acceptable loss, the switch controller 115 may dynamically remap a new lane in the switch device 100b to replace the degraded lane.

The switch controller 115 may perform adaptive signal equalization to the in-band traffic 120 in the switch device 100b. For example, the multiple first electronic devices 105 may provide feedback to the switch controller 115 relative to the workload handled by the multiple first electronic devices 105, and the switch controller 115 may adaptively manage workloads of the multiple first electronic devices 105 to optimize performance of the switch device 100b.

A backup switch controller (not illustrated) may be included in the switch device 100b. The backup switch controller may be a redundant controller relative to the switch controller 115. The backup switch controller may include the same or similar connections as the switch controller 115 relative to the multiple first electronic devices 105 and/or the multiple second electronic devices 110. The backup switch controller may perform the same or similar operations as the switch controller 115.

FIG. 1C illustrates an example switch device 100c. The switch device 100c may include a first DSP device 105a, an nth DSP device 105c, and multiple analog ICs 135. The first DSP device 105a may include a first auxiliary channel 107a, and a first out-of-band channel 109a. The nth DSP device 105c may include an nth auxiliary channel 107c, and an nth out-of-band channel 109c.

The first DSP device 105a, the nth DSP device 105c, and the multiple analog ICs 135 may be the same or similar as the first DSP device 105a, the nth DSP device 105c, and the multiple second electronic devices 110, respectively, of FIG. 1A and may be operable to perform the same or similar functions as described.

The auxiliary channels 107 (e.g., the first auxiliary channel 107a and the second auxiliary channel 107c) may be individually utilized by each of the DSP devices 105a, 105c as an additional lane for in-band traffic between at least the DSP devices 105a, 105c and the multiple analog ICs 135. The auxiliary channels 107 may be used to redundantly transmit in-band traffic relative to another lane included in the DSP devices 105a, 105c prior to a change in configuration to the corresponding DSP devices 105a, 105c. For example, in instances in which the first DSP device 105a includes a lane to a particular analog IC of the multiple analog ICs 135 and the first DSP device 105a is to be reconfigured (e.g., by a switch controller as described herein), the first auxiliary channel 107a may have a lane mapped to the particular analog IC such that the in-band traffic is redundant between the first DSP device 105a and the particular analog IC prior to reconfiguring the lanes associated with the first DSP device 105a (which reconfiguration may otherwise break the connection between the first DSP device 105a and the particular analog IC).

The auxiliary channels 107 may be used for communication between other near DSP devices. For example, in instances in which the first DSP device 105a is disposed spatially near to the nth DSP device 105c, the first DSP device 105a and the nth DSP device 205c may communicate with one another via the auxiliary channels 107. Such communications may be possible as the channels between near-neighbors may be relatively clean, such that physical layer processing may be simplified and may result in power reduction, latency reduction, a lesser amount of equalization, and/or other benefits to the switch device 100c.

The out-of-band channels 109 may be used to communicate the out-of-band traffic (e.g., the out-of-band traffic 125 of FIG. 1B) on a lane separate from the multiple lanes used to communicate in-band traffic. In such instances, the out-of-band channels 109 may not cause blocking or interference to the in-band traffic between at least the DSP devices 105a, 105c and the multiple analog ICs 135.

FIG. 1D illustrates an example aggregated switch device 100d. The aggregated switch device 100d may include a first switch device 100aa, an nth switch device 100ac, and multiple analog crossbar switches 140. The first switch device 100aa and the nth switch device 100ac may individually be the same or similar as the switch device 100b of FIG. 1B.

The aggregated switch device 100d illustrates that any number of the switch devices 100b (e.g., the first switch device 100aa and the nth switch device 100ac) may be aggregated into another switch device and/or connected to other analog crossbar switches. Each of the switch devices 100b may include multiple DSP devices and multiple analog IC and may be further aggregated into the aggregated switch device 100d using the multiple analog crossbar switches 140. As such, the aggregated switch device 100d may be scaled up or down for any size communication need, by adjusting the switch devices 100b and/or the multiple analog crossbar switches 140 to meet the communication demand.

Referring now to FIG. 2, an example switch device 200 may include N DSPs (e.g., DSPs 205a, 205b, 205c, 205d). DSP 205a may include M x Line Rx 202a, M x Line Tx 204a, M x Etx to MxM DSP xbar 206a, and M x Erx to MxM DSP xbar 208a. DSP 205b may include M x Line Rx 202b, M x Line Tx 204b, M x Etx to MxM DSP xbar 206b, and M x Erx to MxM DSP xbar 208b. Nth DSP device 205c may include M x Line Rx 202c, M x Line Tx 204c, M x Etx to MxM DSP xbar 206c, and M x Erx to MxM DSP xbar 208c. DSP 205d may include M x Line Rx 202d, M x Line Tx 204d, M x Etx to MxM DSP xbar 206d, and M x Erx to MxM DSP xbar 208d.

The switch device 200 may include M N x N analog xbar ICs (e.g., analog xbar IC 210a and analog xbar IC 210b). The N DSPs may connect to the M N x N analog xbar ICs in an any-to-any configuration. For example, DSP 205a may connect to analog xbar IC 210a and analog xbar IC 210b up to a number of M xbar ICs. Similarly, DSP 205b and/or DSP 205c and/or DSP 205d may connect to analog xbar IC 210b and analog xbar IC 210b up to a number of M xbar ICs. Therefore, incoming signals may be directed from a DSP 205a, 205b, 205c, 205d to an analog xbar IC 210a.

Similarly, signals may be directed from the analog xbar IC 210a, 210b back to the DSP 205a, 205b, 205c, 205d in an any-to-any configuration. For example, analog xbar IC 210a may connect to DSP 205a, DSP 205b, DSP 205c, DSP 205d up to any n number of DSPs. Similarly, analog xbar IC 210b may connect to DSP 205a, DSP 205b, DSP 205c, DSP 205d up to any n number of DSPs.

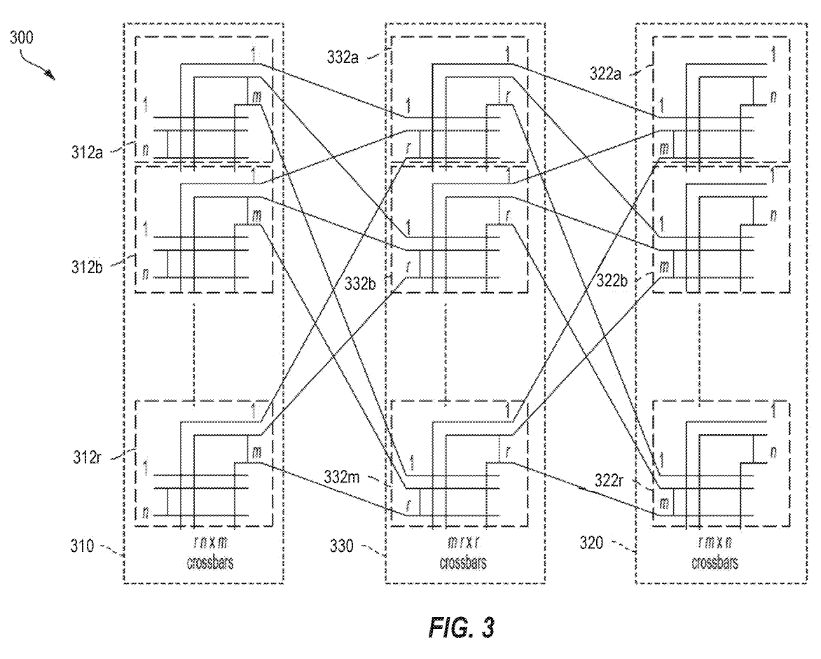

FIG. 3 illustrates an example network topology 300 for a switch device. The network topology 300 may include a first stage 310 including r nxm crossbars, a second stage 330 including m rxr crossbars, and a third stage 320 including r mxn crossbars. The first stage 310 may include r nxm crossbars in which the nxm crossbars may have n inlets and m outlets. For example, crossbars 312a, 312b, and 312r have n inlets and m outlets. The second stage 330 may include m rxr crossbars in which the rxr crossbars have r inlets and r outlets. For example, crossbars 332a, 332b, and 332m have r inlets and r outlets. The third stage 320 may have r mxn crossbars in which the r mxn crossbars have m inlets and n outlets. For example, crossbars 322a, 322b, and 322r have m inlets and n outlets. This network topology may facilitate any-to-any connections between n inputs and n outputs.

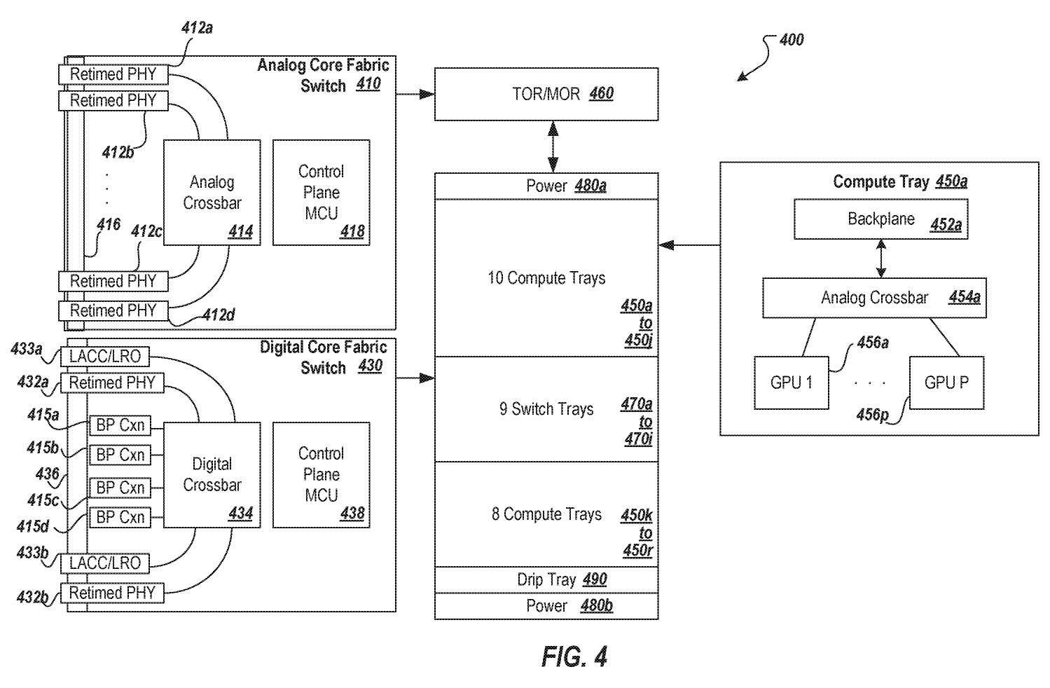

FIG. 4 illustrates an example block diagram for AECS fabrics 400. The AECS fabrics 400 may include one or more of an analog core fabric switch 410, a digital core fabric switch 430, compute trays 450a-j and 450k-r, a top-of-rack (TOR)/middle-of-rack (MOR) 460, switch trays 470a to 470i, power 480a, 480b, or a drip tray 490.

The analog core fabric switch 410 may include one or more retimed PHYs (e.g., retimed PHYs 412a, 412b, 412c, 412d). The retimed PHYs may be coupled to analog crossbar 414. The analog core fabric switch may include a front panel 416 and a control plane microcontroller unit (MCU) 418.

The digital core fabric switch 430 may include one or more retimed PHYs (e.g., retimed PHYs 432a, 432b). The retimed PHYs may be coupled to digital crossbar 434. The digital core fabric switch 430 may include one or more linear active copper cable (LACC)/linear receive optics (LRO) (e.g., LACC/LRO 433a, 433b). The LACC/LROs may be coupled to digital crossbar 434. The digital core fabric switch may include one or more backplane connectors 415a, 415b, 415c, 415d. The digital core fabric switch may include a front panel 436 and a control plane MCU 438.

Compute tray 450a may include a backplane 452a which may be coupled to analog crossbar 454a. The analog crossbar 454a may be coupled to one or more GPUs (e.g., GPU1 456a, GPU P 456p, or the like).

For an analog core fabric switch, a device may include a first set of electronic devices (e.g., retimed modules) including a set of ports to facilitate communications via a set of lanes. The device may include a second set of electronic devices (e.g., analog crossbars) to communicate with the first set of electronic devices via the set of lanes. The second set of electronic devices may be analog crossbar integrated circuits. The retimed modules may include one or more of DSP retimers or one or more digital crossbars. The first set of electronic devices may connect to the second set of electronic devices using an any-to-any configuration. The first set of electronic devices may connect to a rack unit faceplate and the second set of electronic devices may be positioned on a printed circuit board. The device may carry SERDES signals between the first set of electronic devices and the second set of electronic devices. The first set of electronic devices may compensate for impairments caused by the second set of electronic devices.

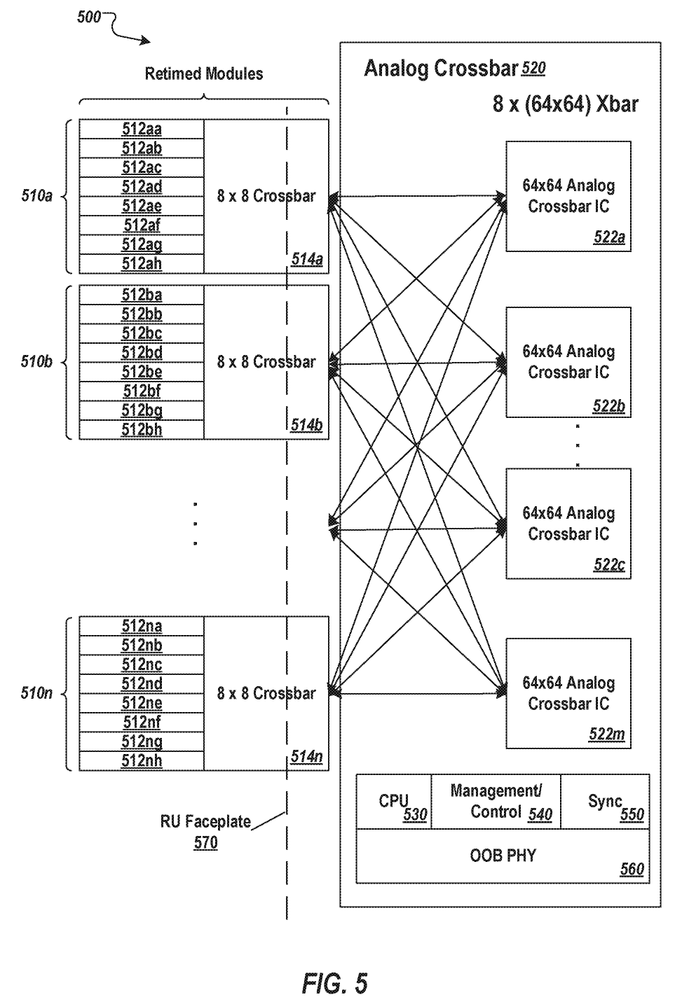

FIG. 5 illustrates an example analog core fabric switch 500. The analog core fabric switch 500 may include one or more retimed modules 510a, 510b, 510n, an analog crossbar 520, a CPU 530, management/control 540, synchronization 550, and out-of-band (OOB) physical layer 560. The one or more retimed modules 510a, 510b, 510n may be coupled to the rack unit faceplate 570.

The one or more retimed modules 510a, 510b, 510n may include one or more DSP retimers. For example, retimed module 510a may include DSP retimers 512aa, 512ab, 512ac, 512ad, 512ae, 512af, 512ag, and 512ah. Retimed module 510b may include DSP retimers 512ba, 512bb, 512bc, 512bd, 512be, 512bf, 512bg, and 512bh. Retimed module 510n may include DSP retimers 512na, 512nb, 512nc, 512nd, 512ne, 512nf, 512ng, and 512nh.

The one or more retimed modules 510a, 510b, 510n may be coupled to a crossbar (e.g., a digital crossbar). For example, DSP retimers 512aa to 512ah may be coupled to crossbar 514a (e.g., an 8 x 8 crossbar). For example, DSP retimers 512ba to 512 bh may be coupled to crossbar 514b. For example, DSP retimers 512na to 512nh may be coupled to crossbar 514n.

The one or more retimed modules 510a, 510b, 510n may be coupled to an analog crossbar 520. The analog crossbar 520 may include one or more analog crossbar ICs 522a, 522b, 522c, 522m. The one or more analog crossbar ICs 522a, 522b, 522c, 522m may be e.g., 64x64 analog crossbar ICs. In this example, the retimed modules 510a, 510b, 510n may include 8x8 digital crossbars and the analog crossbar 520 may include 8 64x64 analog crossbar ICs 522a, 522b, 522c, 522m.

The analog core fabric switch 500 may be an array of switches that may redirect SERDES signals. The retimed modules 510a, 510b, 510n (e.g., DSPs) may compensate for impairments in the analog crossbar 520. The crossbars 514a, 514b, 514n may simplify the analog crossbar 520. The analog core fabric switch may support broadcast and/or multicast.

The analog core fabric switch 500 may have reduced power, reduced latency, and/or reduced cost. The power may be less than about 50 W analog crossbar in a 64 port 800G/1.6T (51.2T/102.4T). The lowest core latency may be less than about 10 ns. The end-to-end latency including the 1.6T DSP may be about 85 ns.

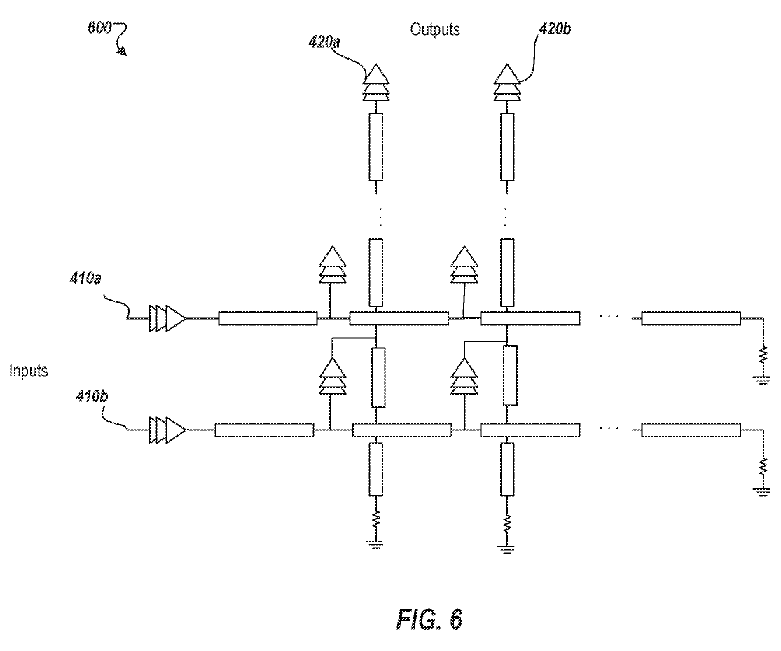

FIG. 6 illustrates an example analog fabric topology 600. The analog fabric topology 600 may include one or more inputs 410a, 410b and may include one or more outputs 420a, 420b. The one or more inputs 410a, 410b may be coupled to the one or more outputs 420a, 420b.

For a digital crossbar SOC, a device may include a first set of electronic devices (e.g., retimed modules) including a set of ports to facilitate communications via a set of lanes. The device may include a second set of electronic devices to communicate with the first set of electronic devices via the set of lanes, in which the second set of electronic devices includes digital crossbars. The retimed modules may include DSP retimers and/or one or more digital crossbars. The first set of electronic devices may connect with the second set of electronic devices using an any-to-any configuration. The first set of electronic devices and the second set of electronic devices may be positioned on an SoC. The device may carry SERDES signals between the first set of electronic devices and the second set of electronic devices.

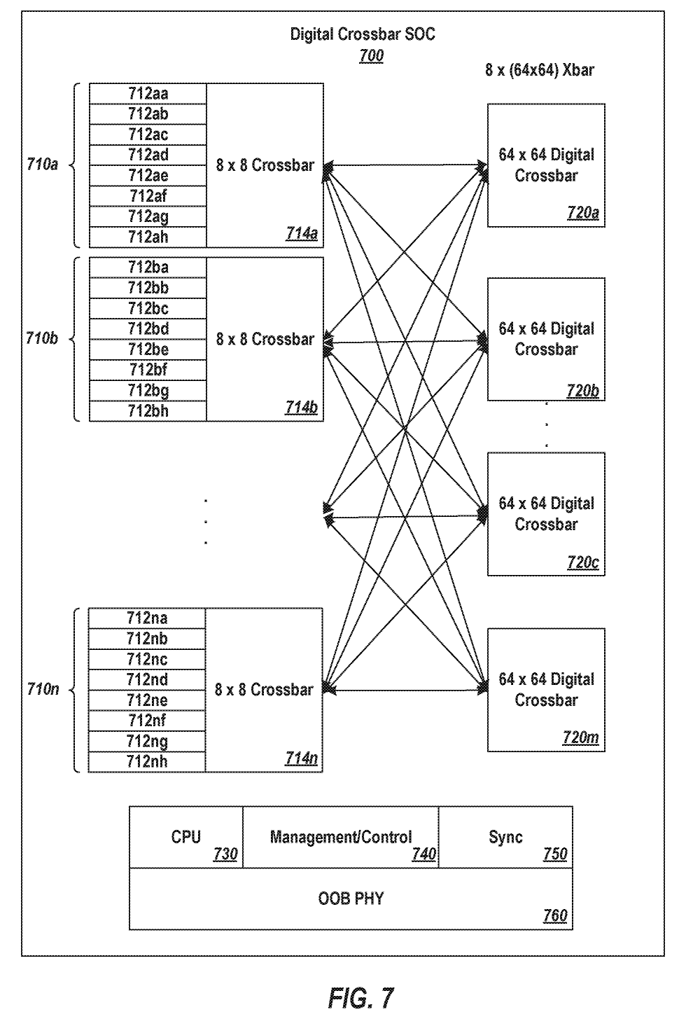

FIG. 7 illustrates an example digital fabric switch SOC 700. The digital fabric switch SOC 700 may include one or more DSPs 710a, 710b, 710n coupled to one or more digital crossbars 720a, 720b, 720c, 720m. The digital fabric switch SOC 700 may include a CPU 730, management/control 740, synchronization 750, and OOB PHY 760.

The one or more DSPs 710a, 710b, 710n may include one or more DSP retimers and a crossbar. For example, DSP 710a may include DSP retimers 712aa, 712ab, 712ac, 712ad, 712ae, 712af, 712ag, and 712ah and may include crossbar 714a. DSP 710b may include DSP retimers 712ba, 712bb, 712bc, 712bd, 712be, 712bf, 712bg, and 712bh and may include crossbar 714b. DSP 710n may include DSP retimers 712na, 712nb, 712nc, 712nd, 712ne, 712nf, 712ng, and 712nh and may include crossbar 714n.

The digital fabric switch SOC 700 may be a 2 layer crossbar with minimal buffering. The digital fabric switch SOC 700 may support fast out-of-band switch reconfiguration e.g., using Ultra Ethernet Fabric Manager. The digital fabric switch SOC 700 may be used for backplanes for scaling up and/or out. The digital fabric switch SOC 700 may be compatible with e.g., digital analog converters, linear active copper cables, and linear receive optics.

The digital fabric switch SOC 700 may have enhanced latency and reduced power when compared to other digital fabric switch SOCs. For example, the latency may be 45 ns end-to-end and the power may be 450 W for 512 lanes of 224 Gbps SERDES.

Signals may be carried from crossbars 714a, 714b, 714n to digital crossbars 720a, 720b, 720c, 720m in an any-to-any configuration. That is, a signal from crossbar 714a may be carried to digital crossbar 720a, or to digital crossbar 720b, or to digital crossbar 720c, or to digital crossbar 720m. In this example, there may be n 8x8 crossbars 714a, 714b, 714n and 8 64x64 digital crossbars 720a, 720b, 720c, 720m.

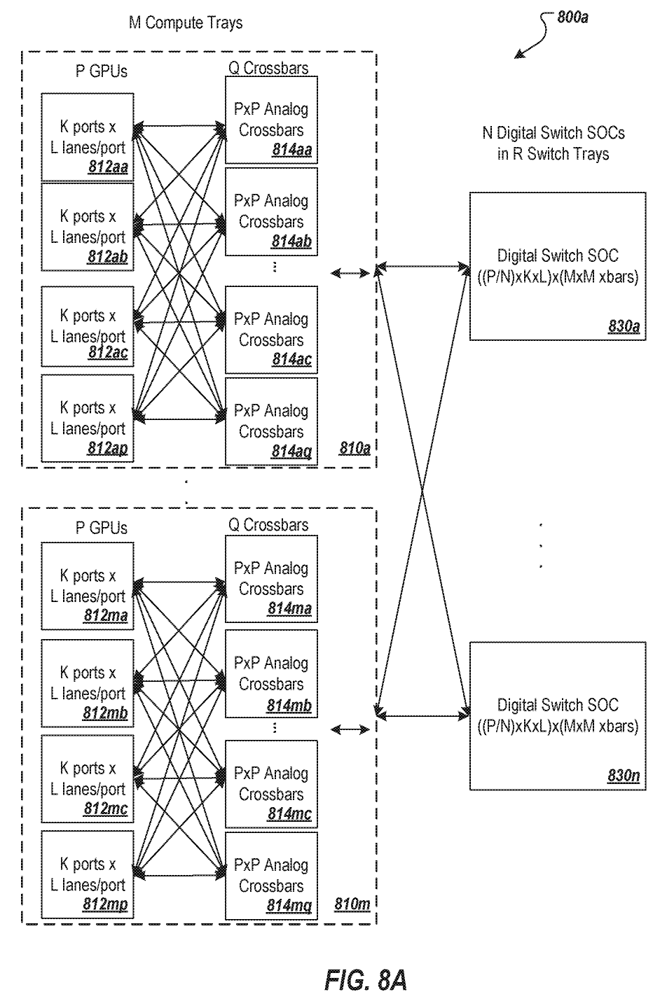

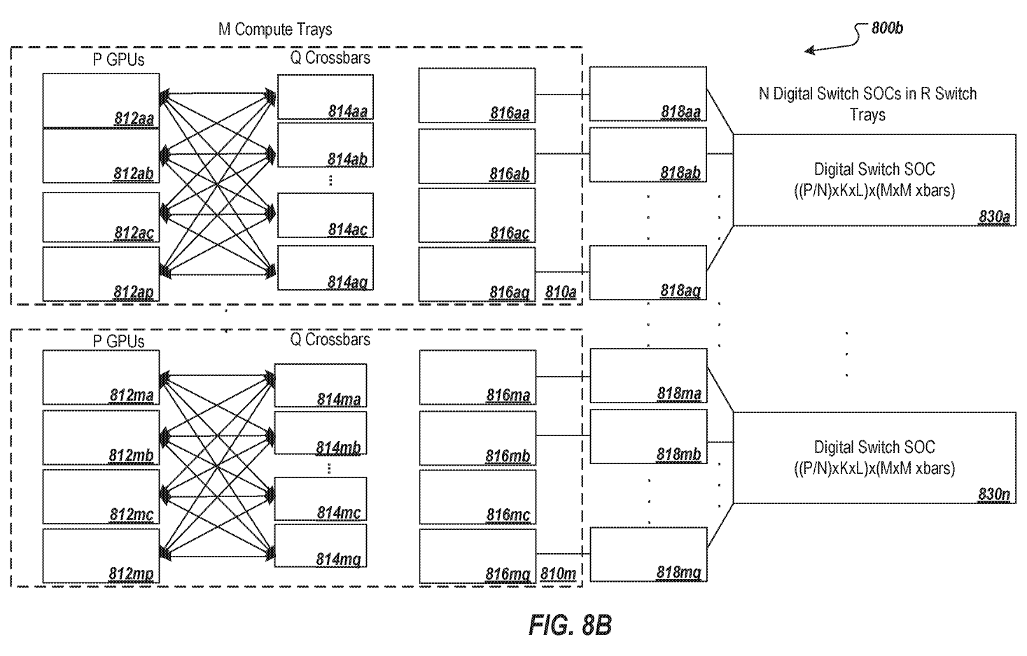

As illustrated in FIG. 8A, a device 800a may include a first set of electronic devices (e.g., DSPs or GPUs) which may include a set of ports to facilitate communications via a set of lanes. The device 800a may include a second set of electronic devices (e.g., crossbars) to communicate with the first set of electronic devices (e.g., DSPs or GPUs) via the set of lanes. The device 800a may include a third set of electronic devices (e.g., digital switch SOCs) that may communicate with the second set of electronics devices via a set of connections. The first set of electronic devices may include digital crossbars. The second set of electronic devices may include analog crossbars. The third set of electronic devices may include digital switch SoCs. The first set of electronic devices and the second set of electronic devices may be located in one or more compute trays. The third set of electronic devices may be located in one or more switch trays. The connections between the second set of electronic devices and the third set of electronic devices may include one or more of electrical connections or photonic connections.

The placement of analog crossbars locally at the compute tray may enhance bandwidth, reduce latency, enhance scalability, and reduce energy consumption. Energy consumption may be reduced because the analog crossbars do not retime or convert the SERDES lanes to the digital domain which may result in a multifold reduction in power used for the switching function. In addition, the analog crossbars may perform amplification and equalization comparable to LACC which may increase the reach achievable across a backplane. The analog crossbars may be coupled to switch trays with digital retimed SOCs.

Specifically, placing compute trays with local crossbars and using a simplified digital switch SOC may reduce the power, latency, and size in an architecture that has two layers of switching and uses 180 compute trays with 4 GPUs per compute tray. The architecture may scale to more than 10 x the radix of existing architectures with a compute tray power of about 10W per compute tray resulting in a 0.17% power increase when compared to existing compute trays with less than 10 ns of latency. The switch tray power may be less than 4.5 kW total which may be a 45% power reduction when compared to existing switch trays.

FIG. 8A illustrates an example of compute trays, crossbars, and the connections between them. A device 800a may include M compute trays 810a, 810m and N digital switch SOCs 830a, 830n in R Switch Trays. The M compute trays 810a, 810m may include P GPUs and Q Crossbars. The P GPUs may have K GPU ports and the K GPU ports may have L lanes. The combination of the K GPU ports with the L lanes and the Q crossbars may form a full crossbar functionality with lane-level granularity. The Q crossbars may include two groups of K x L x (P x P) analog crossbars (there may be two groups to accommodate bidirectionality). PxP crossbars may be connected to one of the N digital switch SOCs 830a, 830n.

The compute trays may include a number of GPUs and crossbars. For example, compute tray 810a may include GPUs 812aa, 812ab, 812ac, and 812ap and crossbars 814aa, 814ab, 814ac, 814aq. For example, compute tray 810m may include GPUs 812ma, 812mb, 812mc, and 812mp and crossbars 814ma, 814mb, 814mc, and 814mq.

The compute trays may have a total of M x P x K x L bidirectional SERDES connections that may use all-to-all connectivity. M may refer to the number of compute trays, P may refer to the number of GPUs per compute tray, K may refer to the number of ports per GPU, and L may refer to the number of bidirectional links per port.

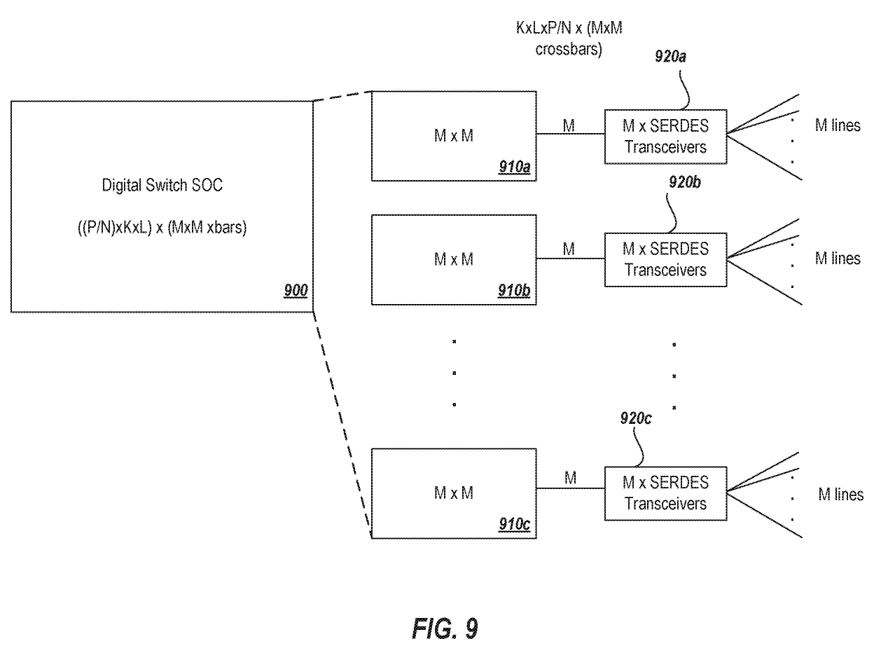

In the NVL72, M x P x K x L may equate to 5184 SERDES lanes. Using local compute tray crossbars may simplify the switch tray crossbars because full crossbar functionality may be replaced by a layer of smaller (e.g. MxM) crossbars that may not be cross-connected, as illustrated in FIG. 9. Because crossbar complexity may rise at least quadratically with crossbar size (without considering benefits to clock tree and timing closure), the full crossbar for these SERDES lanes may have a complexity which may be (PxKxL)greater than PxKxL smaller MxM crossbars. For the example of an NVL72, this is equivalent to a 288-fold reduction in crossbar die area and power consumption, and, when latency is roughly proportional to linear dimensions of the crossbar, a 17-fold reduction in latency.

Signals may be directed from the P GPUs 812aa, 812ab, 812ac, 812ap to the Q crossbars 814aa, 814ab, 814ac, 814aq for the compute tray 810a in an any-to-any configuration. That is, signals from GPU 812aa may be directed to crossbar 814aa, or crossbar 814ab, or crossbar 814ac, or crossbar 814aq. Similarly, signals from GPUs 812ab, 812ac, 812ap may be directed to crossbar 814aa, or crossbar 814ab, or crossbar 814ac, or crossbar 814aq. Similarly, signals may be directed from the P GPUs 812ma, 812mb, 812mc, 812mp to the Q crossbars 814ma, 814mb, 814mc, 814mq in a similar manner.

The signals may be directed from the Q crossbars in compute trays 810a, 810m to the digital switch SOCs 830a, 830n in an any-to-any configuration in which the signals from compute tray 810a may be directed to digital switch SOC 830a, or digital switch SOC 830n and the signals from compute tray 810m may be directed to digital switch SOC 830a, or digital switch SOC 830n.

There may be PxKxL connections between the analog crossbars 814aa, 814ab, 814ac, 814aq in compute tray 810a and the N digital switch SOCs 830a, 830n. Consequently, there may be (P/N)xKxL connections between the analog crossbars 814aa, 814ab, 814ac, 814aq in compute tray 810a and the digital switch SOC 830a and there may be (P/N)xKxL connections between the analog crossbars 814aa, 814ab, 814ac, 814aq in compute tray 810a and the digital switch SOC 830n. The connections between analog crossbars 814ma, 814mb, 814mc, 814mq in compute tray 810m to N digital switch SOCs 830a, 830n may be similar.

The scenario described in relation to FIG. 8A may be directly applicable to copper backplanes and cabling. The same approach may be applied to networks based on photonics and optics, by attaching the local crossbars to photonics.

FIG. 8B illustrates a device 800b including M compute trays that may be coupled to N digital switch SOCs in R switch trays using photonics. For example, compute tray 810a may include photonics interface 816aa, 816ab, 816ac, 816aq which may be coupled to photonics interface 818aa, 818ab, 818aq which may be coupled to digital switch SOC 830a. Compute tray 810m may include photonics interface 816ma, 816mb, 816mc, 816mq which may be coupled to photonics interface 818ma, 818mb, 818mq which may be coupled to digital switch SOC 830n.

The photonics interfaces may be one or more of fast-narrow interconnects, slow-wide interfaces, or microLED arrays. Some examples of fast-narrow interconnects may include fast narrow co-packaged optics. Some examples of slow wider interfaces may include vertical cavity surface emitting laser (VCSEL), universal chiplet interconnect express (UCIe), or the like.

Crossbars may have high-speed SERDES (e.g., “fast-narrow” interconnects) or with slow-wide interfaces such as UCIe. The UCIe, being much slower speed when compared to high-speed SERDES, may be conducive to analog and digital crossbar implementations. A slow-wide variant may be useful under conditions where the density of lines and die connections (e.g., bumps or copper pillars) becomes very high. Furthermore, the reaches may be much shorter than a conventional PCB.

Consequently, slow-wide may achieve two significant advantages over longer-reach fast-narrow interconnects. First, slow-wide may have enhanced pJ/b energy efficiencies (~<0.1 pJ/b). This condition may exist in chiplet systems and may be useful as the cost and size of chiplet interposers improve with advancing technology. Second, slow-wide may have much higher edge densities (greater than 5 Tbps/mm bidirectional with existing UCIe and interconnect technology).

In addition or alternatively, slow-wide interfaces may be combined with the advent of slow-wide photonics interfaces to create energy-efficient interconnects that may reach much further than copper.

FIG. 9 illustrates a digital switch SOC 900. The digital switch SOC 900 may include one or more (e.g., (P/N)xKxL) MxM crossbars 910a, 910b, 910c. The one or more MxM crossbars 910a, 910b, 910c may direct data to M x SERDES transceivers 920a, 920b, 920c. The M x SERDES transceivers 920a, 920b, 920c may have M lines to and/or from compute trays. Thus, the digital switch SOC 900 may reduce a full crossbar to independent M x M crossbars which may provide O (1/100) switch simplification with fewer switches and shorter wire lengths when compared to a baseline. The digital switch SOC 900 may also allow for additional space to grow the GPU cluster, thus providing a scalable architecture.

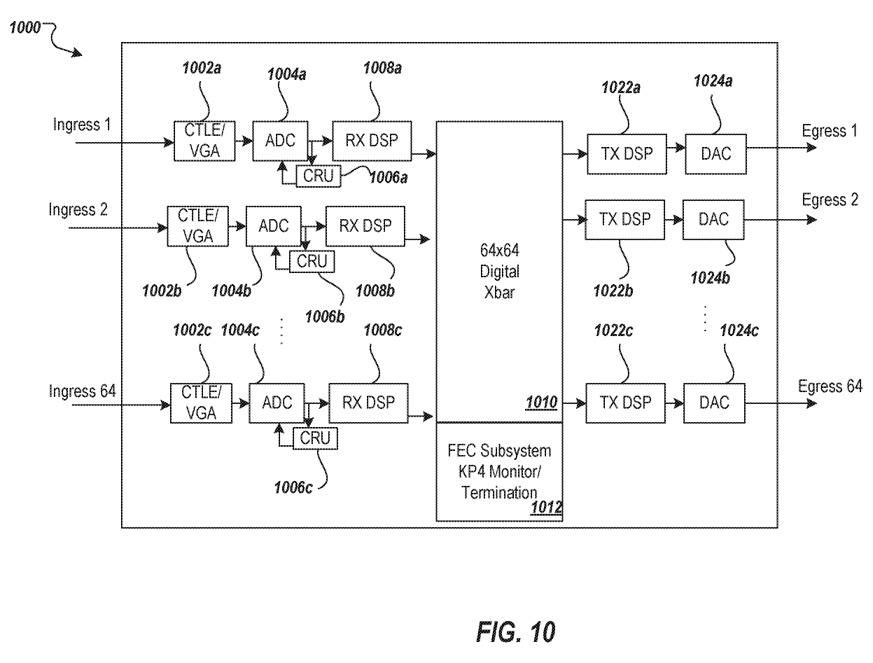

FIG. 10 illustrates a digital circuit switch SOC 1000. The digital circuit switch SOC 1000 may include one or more ingresses (e.g., 64 ingresses) and one or more egresses (e.g., 64 egresses). The one or more ingresses and the one or more egresses may carry e.g., high speed differential 200 Gbps pulse amplitude modulation (PAM)4 signals. The 200 GHz signaling over a channel may have an insertion loss of about 40 dB. Low-speed control interfaces may include e.g., serial peripheral interface (SPI) and/or management data input/output (MDIO). An interface (e.g., SPI Flash) may be coupled to memory (e.g., external Flash Memory) to store the firmware binary for the embedded CPU subsystem. Pulse width modulation (PWM) interfaces may provide dynamic voltage scaling control for the digital and analog supply rails. Internal clocking may be based on a reference clock (e.g., 156.25 MHz external reference clock).

The one or more ingresses may be coupled to one or more ingress paths including one or more of an equalizer and/or amplifier (e.g., continuous time liner equalization (CTLE)/variable gain amplifier (VGA) 1002a, 1002b, 1002c an analog to digital converter (ADC) 1004a, 1004b, 1004c, a clock recovery unit (CRU) 1006a, 1006b, 1006c, or an RX DSP 1008a, 1008b, 1008c. The one or more ingress paths may be coupled to a digital crossbar 1010 (e.g., 64 x 64). The digital crossbar 1010 may be coupled to one or more egress paths including one or more of a TX DSP 1022a, 1022b, 1022c, a digital-to-analog converter (DAC) 1024a, 1024b, 1024c, or the like. The digital circuit switch SOC 1000 may include a forward error correction (FEC) subsystem 1012 for monitoring and/or termination (e.g., using KP4 FEC). The digital circuit switch SOC 1000 may include functionality for fast Fourier transforms (FFT), histograms, pseudo-random binary sequence (PRBS)/bit error rate testing (BERT), MEM capture/playback, temperature sensing, clock generation, embedded CPU subsystems, dynamic voltage scaling (DVS), internal voltage regulation, or the like.

The digital circuit switch SOC 1000 may support various DSP functions such as Tx digital pre-emphasis (e.g., TX finite impulse response (FIR)), receive feed forward equalization (FFE), and a low power maximum likelihood sequence estimation (MLSE)-lite PAM4 detector. Because of the enhanced signal integrity for 200 Gbps signals, the digital circuit switch SOC 1000 may be used for switch tray applications and/or as a reconfigurable Clos fabric.

For example, the reconfigurable Clos fabric may include a topology including an ingress stage, a middle stage, and an egress stage, as illustrated in FIG. 3. Alternatively or in addition, the reconfigurable Clos fabric may include different blocking characteristics such as a strict-sense non-blocking Clos fabric, or a rearrangeably non-blocking Clos fabric. Alternatively or in addition, the Clos fabric may have an odd number of stages other than 3. That is, a Clos fabric of 5 stages, 7 stages, 9 stages, or the like may be used.

Different standards may be supported in the digital circuit switch SOC 1000 including one or more of Optical Internetworking Forum (OIF) Common Electrical I/O (CEI)-224G- long reach (LR)-pulse amplitude modulation (PAM)4, Institute of Electrical and Electronics Engineers (IEEE) 802.3dj, Infiniband extreme data rate (XDR), and/or ultra accelerator link (UALink) (e.g., UALink 1.0).

Because the energy and latency penalties for an analog electrical circuit switch may be low relative to energy and latency penalties imposed by digital switches, a layer of redundancy switching (i.e., a redundancy crossbar) may be implemented between SOCs and co-packaged optics (CPO) or front-panel modules. When a module fails (such as during link flap), the redundancy switching may quickly reconnect the affected port of the SOC to a redundant link. For an SOC with N ports, and the switch as R redundant ports, a crossbar may switch any of the N ports to any of the R redundant ports.

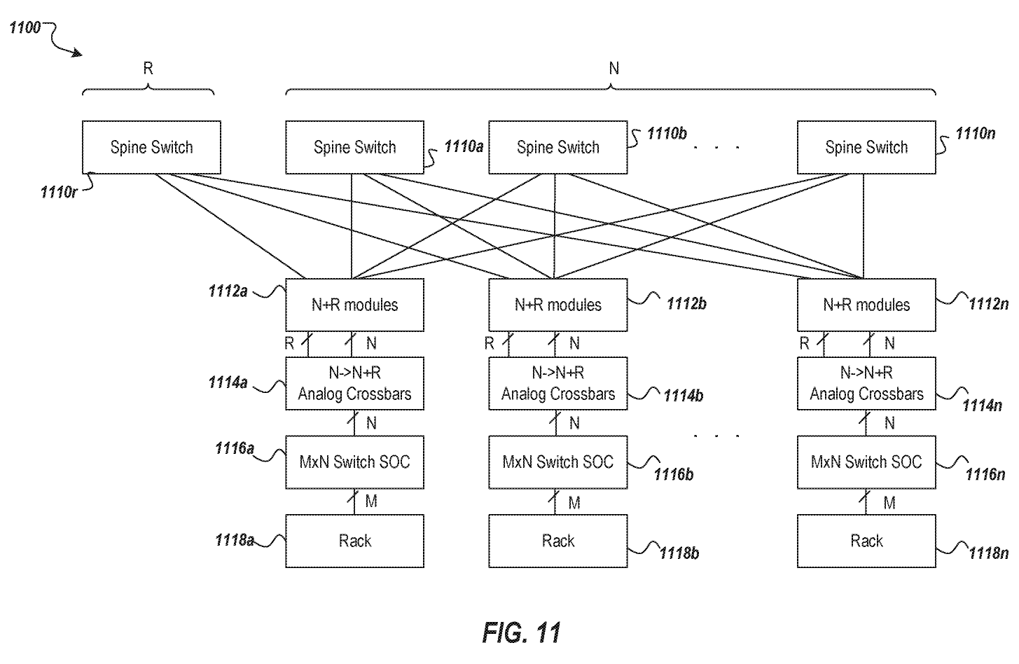

Such a switch is illustrated in FIG. 11, where R may be small and N may be large in order to amortize the cost of redundancy over large numbers of ports due to the low probability of link failure. The redundancy crossbar may include analog equalization and amplification. The redundancy crossbar may be configured and controlled by local or remote controllers but local may be used in order to reduce latency between detection of a failure and fail-over to a redundant port.

As illustrated in FIG. 11, redundant ports may be connected in a network 1100 in a spine and leaf configuration. N Spine switches 1110a, 1110b, 1000n may be coupled to N N+R modules 1112a, 1112b, 1112n. That is, spine switch 1110a may be coupled to N+R modules 1112a, 1112b, 1112n, spine switch 1110b may be coupled to N+R modules 1112a, 1112b, 1112n, and spine switch 1110n may be coupled to N+R modules 1112a, 1112b, 1112n.

The N N+R modules 1112a, 1112b, 1112n may be coupled to N to R redundancy crossbars 1114a, 1114b, 1114n using R + N connections. That is, N+R module 1112a may be coupled to N to R redundancy crossbar 1114a using R+ N connections, N+R module 1112b may be coupled to N to R redundancy crossbar 1114b using N+R connections, and N+R module 1112n may be coupled to N to R redundancy crossbar 1114n using N+R connections. The N N+R modules 1112a, 1112b, 1112n may be e.g., quad small form-factor pluggable double density (QSFP-DD) or CPO.

The N to R redundancy crossbars 1114a, 1114b, 1114n may be coupled to N MxN switch SOCs 1116a, 1116b, 1116n using N connections. That is, N to R redundancy crossbar 1114a may be coupled to MxN switch SOC 1116a using N connections, N to R redundancy crossbar 1114b may be coupled to MxN switch SOC 1116b using N connections, and N to R redundancy crossbar 1114n may be coupled to MxN switch SOC 1116n using N connections.

The MxN switch SOCs 1116a, 1116b, 1116n may be coupled to racks 1118a, 1118b, 1118n using M connections. That is, MxN switch SOC 1116a may be coupled to rack 1118a using M connections, MxN switch SOC 1116b may be coupled to rack 1118b using M connections, and MxN switch SOC 1116n may be coupled to rack 1118n using M connections.

Redundancy spine switch 1110r may be coupled to N+R modules 1112a, 1112b, 1112n. For example, when the number of redundancy spine switches is equal to 1, redundancy spine switch 1110r may be coupled to N+R module 1112a, 1112b, 1112n. For additional redundancy spine switches, additional connections may be added to the N+R modules 1112a, 1112b, 1112n.

Some scale-up architectures may have port-level switching granularity (e.g., where each port may be L=4 SERDES lane). As disclosed herein, lane-level granularity may be provided. Coarser granularity for port-level switching may be implemented in addition or alternatively. As an example, if the system switches at a port granularity (where L SERDES lanes in the port go to the same end GPU), then the crossbars may switch groups of L lanes together.

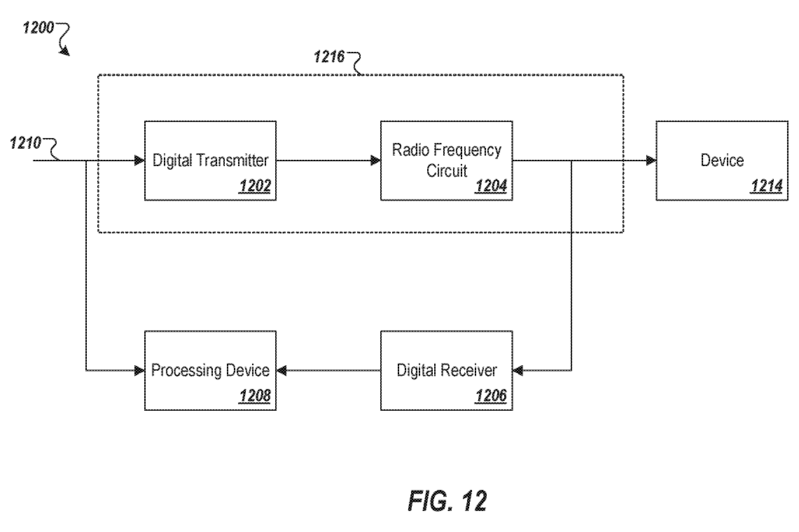

FIG. 12 illustrates a block diagram of an example communication system 1200 configured for implementing one or more of the examples described above. The communication system 1200 may include a digital transmitter 1202, a radio frequency circuit 1204, a device 1212, a digital receiver 1206, and a processing device 1208. The digital transmitter 1202 and the processing device 1208 may be configured to receive a baseband signal via connection 1210. A transceiver 1214 may comprise the digital transmitter 1202 and the radio frequency circuit 1204.

The communication system 1200 may include a system of devices configured to communicate with one another via wired or wireline connections. For example, a wired connection in the communication system 1200 may include one or more Ethernet cables, one or more fiber-optic cables, and/or other similar wired communication mediums. Alternatively, or additionally, the communication system 1200 may include a system of devices configured to communicate via one or more wireless connections. For example, the communication system 1200 may include devices configured to transmit and/or receive radio waves, microwaves, ultrasonic waves, optical waves, electromagnetic induction, and/or similar wireless communications. Additionally, the communication system 1200 may include combinations of wireless and/or wired connections. The communication system 1200 may include one or more devices that obtain a baseband signal, perform operations to the baseband signal to generate a modified baseband signal, and transmit the modified signal to one or more loads.

The communication system 1200 may include one or more communication channels that communicatively couple systems and/or devices included in the communication system 1200. For example, the transceiver 1214 may be communicatively coupled to the device 1212.

The transceiver 1214 may be configured to obtain a baseband signal. For example, the transceiver 1214 may generate a baseband signal and/or receive a baseband signal from another device. The transceiver 1214 may then transmit the baseband signal to a separate device, such as the device 1212. Alternatively, the transceiver 1214 may modify, condition, and/or transform the baseband signal before transmitting it. For example, the transceiver 1214 may include a quadrature up-converter and/or a DAC to modify the baseband signal. Alternatively, the transceiver 1214 may include a direct radio frequency (RF) sampling converter configured to modify the baseband signal.

The digital transmitter 1202 may obtain a baseband signal via connection 1210 and up-convert the baseband signal. For example, the digital transmitter 1202 may include a quadrature up-converter. The digital transmitter 1202 may integrate a DAC that converts the baseband signal to an analog or continuous-time signal. The DAC architecture may include a direct RF sampling DAC, or the DAC may be implemented as a separate element from the digital transmitter 1202.

The transceiver 1214 may include subcomponents to prepare and transmit the baseband signal. For example, the transceiver 1214 may include an RF front end, which may include a power amplifier (PA), a digital transmitter (e.g., 1202), a digital front end, an IEEE 1588v2 device, a Long-Term Evolution (LTE) physical layer (L-PHY), an (S-plane) device, a management plane (M-plane) device, an Ethernet MAC/physical coding sublayer (PCS), a resource controller/scheduler, and the like. The radio frequency circuit 1204 of the transceiver 1214 may synchronize with the resource controller via the S-plane device, enabling high-accuracy timing relative to a reference clock.

The transceiver 1214 may receive the baseband signal from a signal generator or a transducer, such as a microphone. The transceiver 1214 may generate or transmit this baseband signal to another device, such as the device 1212.

The device 1212 may receive a transmission from the transceiver 1214. The radio frequency circuit 1204 may transmit a digital signal received from the digital transmitter 1202 to the device 1212 or to the digital receiver 1206. The digital receiver 1206 may then process the digital signal and send it to the processing device 1208.

The processing device 1208 may be a standalone system or part of another device. For instance, the processing device 1208 may be included in the transceiver 1214 or operate as an independent system capable of communicating with the transceiver 1214 and/or the device 1212. The processing device 1208 may send and/or receive transmissions from these devices.

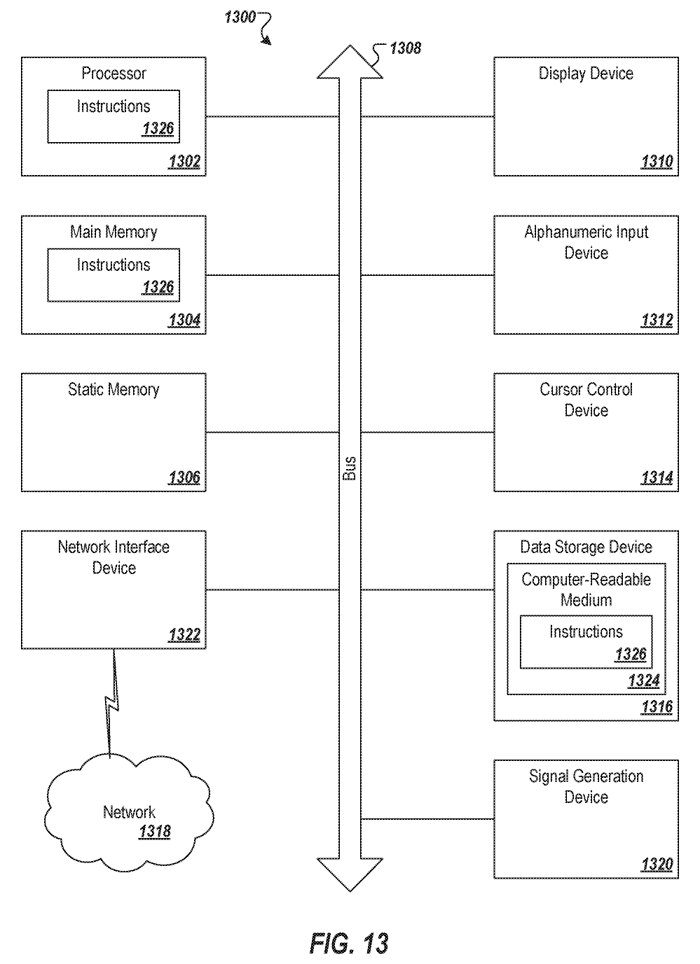

FIG. 13 illustrates a diagrammatic representation of a machine in the example form of a computing device 1300 within which a set of instructions, for causing the machine to perform any one or more of the methods discussed herein, may be executed. The computing device 1300 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in a client-server network environment. Further, while only a single machine is illustrated, the term "machine" may also include any collection of machines that individually or jointly execute a set (or multiple sets) of instructions to perform any one or more of the methods discussed herein.

Device 1300 includes a processing device (e.g., a processor) 1302, a main memory 1304 (e.g., read-only memory (ROM), flash memory, dynamic random access memory (DRAM) such as synchronous DRAM (SDRAM)), a static memory 1306 (e.g., flash memory, static random access memory (SRAM)) and a data storage device 1316, which communicate with each other via a bus 1308.

Processing device 1302 represents one or more general-purpose processing devices such as a microprocessor, central processing unit, or the like. More particularly, the processing device 1302 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1302 may also include one or more special-purpose processing devices such as an application-specific integrated circuit (ASIC), a field-programmable gate array (FPGA), a digital signal processor (DSP), network processor, or the like. The processing device 1302 is configured to execute instructions 1326 for performing the operations and steps discussed herein.

The computing device 1300 may further include a network interface device 1322 which may communicate with a network 1318. The computing device 1300 also may include a display device 1310 (e.g., a liquid crystal display (LCD) or a cathode ray tube (CRT)), an alphanumeric input device 1312 (e.g., a keyboard), a cursor control device 1314 (e.g., a mouse), and a signal generation device 1320 (e.g., a speaker). In at least one example, the display device 1310, the alphanumeric input device 1312, and the cursor control device 1314 may be combined into a single component or device (e.g., an LCD touch screen).

The data storage device 1316 may include a computer-readable storage medium 1324 on which is stored one or more sets of instructions 1326 embodying any one or more of the methods or functions described herein. The instructions 1326 may also reside, completely or at least partially, within the main memory 1304 and/or within the processing device 1302 during execution thereof by the computing device 1300, the main memory 1304 and the processing device 1302 also constituting computer-readable media. The instructions may further be transmitted or received over a network 1318 via the network interface device 1322.

While the computer-readable storage medium 1324 is shown in an example to be a single medium, the term "computer-readable storage medium" may include a single medium or multiple media (e.g., a centralized or distributed database and/or associated caches and servers) that store the one or more sets of instructions. The term "computer-readable storage medium" may also include any medium that is capable of storing, encoding, or carrying a set of instructions for execution by the machine and that cause the machine to perform any one or more of the methods of the present disclosure. The term "computer-readable storage medium" may accordingly be taken to include, but not be limited to, solid-state memories, optical media, and magnetic media.

### Examples:

Example 1 may include a switch device, including: a first set of electronic devices comprising a set of ports that facilitate communications via a set of lanes; a second set of electronic devices that communicates with the first set of electronic devices via the set of lanes; and a switch controller to dynamically map the set of lanes between at least the first set of electronic devices and the second set of electronic devices.

Example 2 may include the switch device of Example 1, in which the first set of electronic devices are individually configured to support functionality using layer 1, layer 2, and layer 3 protocols with respect to the communications.

Example 3 may include the switch device of Example 1, in which the first set of electronic devices are individually configured to transmit and receive in-band traffic from a device.

Example 4 may include the switch device of Example 3, in which the in-band traffic from the device to the first set of electronic devices are transmitted via a line, and the line includes one of an electrical-to-electrical connection, an optical-to-optical connection, an electrical-to-optical connection, or an optical-to-electrical connection.

Example 5 may include the switch device of Example 1, in which the first set of electronic devices are digital signal processors and the second set of electronic devices are analog circuit switch integrated circuits.

Example 6 may include the switch device of Example 1, in which the first set of electronic devices are digital signal processors and the second set of electronic devices are analog optical circuit switch integrated circuits.

Example 7 may include the switch device of Example 1, in which the second set of electronic devices includes a second set of ports and one or more of the set of ports are individually coupled with one or more of the second set of ports using at least one lane of the set of lanes.

Example 8 may include the switch device of Example 1, in which the switch controller is a microcontroller unit or a digital signal processor.

Example 9 may include the switch device of Example 1, in which the switch controller is connected to the first set of electronic devices and to the second set of electronic devices using a second connection and the second connection is used to transmit out-of-band traffic between at least the switch controller and the first set of electronic devices and the second set of electronic devices.

Example 10 may include the switch device of Example 9, in which the out-of-band traffic uses a different network than in-band traffic between the switch device and a device.

Example 11 may include the switch device of Example 9, in which the out-of-band traffic uses a different physical layer protocol than in-band traffic between the switch device and a device.

Example 12 may include the switch device of Example 1, in which the switch controller is programmable to facilitate the dynamic mapping of the set of lanes based on real-time data traffic in the switch device.

Example 13 may include the switch device of Example 1, in which the switch device is reconfigurable without retiming such that each lane of the plurality of lanes uses less than 50 milliwatts.

Example 14 may include the switch device of Example 1, in which the switch controller is configured to reserve a portion of bandwidth associated with in-band traffic on a per lane of the set of lanes basis.

Example 15 may include the switch device of Example 1, in which each of the first set of electronic devices comprise memory used as a buffer for input traffic and output traffic.

Example 16 may include the switch device of Example 1, in which the switch controller monitors each lane of the set of lanes.

Example 17 may include the switch device of Example 1, further including a backup switch controller having the same connections relative to the first set of electronic devices and the second set of electronic devices as the switch controller, and perform one or more functions performed by the switch controller.

Example 18 may include the switch device of Example 1, in which the first set of electronic devices, the second set of electronic devices, and the switch controller are connected with each other using cables to reduce crosstalk between the set of lanes.

Example 19 may include the switch device of Example 1, in which the first set of electronic devices, the second set of electronic devices, and the switch controller for a crossbar device that may be used in conjunction with one or more additional crossbar devices.

Example 20 may include the switch device of Example 1, in which the first plurality of electronic devices individually include at least one additional lane for communications via the set of lanes.

The embodiments described herein may be embodied in systems, apparatus, methods, computer programs, and/or articles depending on the desired configuration. Any methods or the logic flows depicted in the accompanying figures and/or described herein do not necessarily require the particular order shown, or sequential order, to achieve desirable results. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. The implementations described above can be directed to various combinations and sub-combinations of the disclosed features and/or combinations and sub-combinations of further features noted above. Furthermore, above-described advantages are not intended to limit the application of any issued claims to processes and structures accomplishing any or all of the advantages. Furthermore, any reference to this disclosure in general or use of the word "embodiment" in the singular is not intended to imply any limitation on the scope of the claims set forth below. Multiple embodiments may be set forth according to the limitations of the multiple claims issuing from this disclosure, and such claims accordingly define the embodiment(s) herein, and their equivalents, that are protected thereby.

In the claims, any reference signs placed between parentheses shall not be construed as limiting the claim. The word "comprising" or "including" does not exclude the presence of elements or steps other than those listed in a claim. In a device claim enumerating several means, several of these means may be embodied by one and the same item of hardware. The word "a" or "an" preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

As used herein, the singular form of “a”, “an”, and “the” include plural references unless the context clearly dictates otherwise. As used herein, the statement that two or more parts or components are “coupled” shall mean that the parts are joined or operate together either directly or indirectly (i.e., through one or more intermediate parts or components, so long as a link occurs). As used herein, “directly coupled” means that two elements are directly in contact with each other. As used herein, “fixedly coupled” or “fixed” means that two components are coupled so as to move as one while maintaining a constant orientation relative to each other. As used herein, “operatively coupled” means that two elements are coupled in such a way that the two elements function together. It is to be understood that two elements “operatively coupled” does not require a direct connection or a permanent connection between them. As utilized herein, “substantially” means that any difference is negligible, or that such differences are within an operating tolerance that are known to persons of ordinary skill in the art and provide for the desired performance and outcomes as described in one or more embodiments herein. Descriptions of numerical ranges are endpoints inclusive.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality). Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

Embodiments described as being implemented in hardware should not be limited thereto, but can include embodiments implemented in software, or combinations of software and hardware, and vice-versa, as will be apparent to those skilled in the art, unless otherwise specified herein. In the exemplary embodiments described herein, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

Although the description provided above provides detail for the purpose of illustration based on what is currently considered to be the most practical and preferred embodiments, it is to be understood that such detail is solely for that purpose and that the disclosure is not limited to the expressly disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A device, comprising:
a first plurality of electronic devices comprising a plurality of ports operable to facilitate communications via a plurality of lanes;
a second plurality of electronic devices operable to communicate with the first plurality of electronic devices via the plurality of lanes; and
a third plurality of electronic devices operable to communicate with the second plurality of electronics devices via a plurality of connections.

2. The device of claim 1, wherein the first plurality of electronics devices comprises one or more of digital signal processors or graphic processing units.

3. The device of claim 1, wherein the first plurality of electronics devices comprises one or more digital crossbars.

4. The device of claim 1, wherein the second plurality of electronic devices comprises analog crossbars.

5. The device of claim 1, wherein the third plurality of electronic devices comprises digital switch systems on chip (SoC).

6. The device of claim 1, wherein the first plurality of electronic devices and the second plurality of electronic devices are located in one or more compute trays, and wherein the third plurality of electronic devices are located in one or more switch trays.

7. The device of claim 1, wherein the plurality of connections comprises one or more of electrical connections or photonic connections.

8. A device, comprising:
a first plurality of electronic devices comprising a plurality of ports operable to facilitate communications via a plurality of lanes; and
a second plurality of electronic devices operable to communicate with the first plurality of electronic devices via the plurality of lanes, wherein the second plurality of electronic devices comprises analog crossbar integrated circuits.

9. The device of claim 8, wherein the first plurality of electronic devices comprises retimed modules.

10. The device of claim 9, wherein the retimed modules comprises one or more digital signal processor (DSP) retimers and one or more digital crossbars.

11. The device of claim 8, wherein the first plurality of electronic devices are operable to connect with the second plurality of electronic devices using an any-to-any configuration.

12. The device of claim 8, wherein the first plurality of electronic devices are operable to connect to a rack unit faceplate and the second plurality of electronic devices are positioned on a printed circuit board.

13. The device of claim 8, wherein the device is operable to carry serializer/deserializer (SERDES) signals between the first plurality of electronic devices and the second plurality of electronic devices.

14. The device of claim 8, wherein the first plurality of electronic devices is operable to compensate for impairments caused by the second plurality of electronic devices.

15. A device, comprising:
a first plurality of electronic devices comprising a plurality of ports operable to facilitate communications via a plurality of lanes; and
a second plurality of electronic devices operable to communicate with the first plurality of electronic devices via the plurality of lanes, wherein the second plurality of electronic devices comprises digital crossbars.

16. The device of claim 15, wherein the first plurality of electronic devices comprises retimed modules.

17. The device of claim 16, wherein the retimed modules comprises one or more digital signal processor (DSP) retimers and one or more digital crossbars.

18. The device of claim 15, wherein the first plurality of electronic devices are operable to connect with the second plurality of electronic devices using an any-to-any configuration.

19. The device of claim 15, wherein the first plurality of electronic devices and the second plurality of electronic devices are positioned on a system on chip (SoC).

20. The device of claim 15, wherein the device is operable to carry serializer/deserializer (SERDES) signals between the first plurality of electronic devices and the second plurality of electronic devices.
